(19) United States
(12) Patent Application Publication
(10) Pub. No.: US 2008/0083435 A1
(43) Pub. Date: Apr. 10, 2008

(54) METHOD OF INHIBITING CORROSION IN STORAGE AND TRANSPORT VESSELS

(76) Inventors: Craig W. Myers, Lisle, IL (US); Phillip E. Bureman, Olathe, KS (US)

Correspondence Address: Edward O.Yonter;Patent and Licensing Department, Nalco Company, 1601 West Diehl Road, Naperville, IL, 60563-1198, US

(21) Appl. No.: 11/539,371

(22) Filed: Oct. 6, 2006

(51) Int. Cl. B08B 7/00

(52) U.S. Cl. 134/42

(57) ABSTRACT

This invention provides a method of inhibiting corrosion on a vessel with particular relevance to storage or transport vessels holding corrosive materials. The invention also provides a method for preventing contamination and maintaining quality of materials stored or transported within a vessel. The method includes providing a new or freshly cleaned storage or transport vessel and applying a water-based corrosion inhibitor or an organic solvent-based corrosion inhibitor to the inner surface of the vessel. The vessel is optionally exposed to heat or airflow to facilitate drying of the surface.

### TECHNICAL FIELD

The invention relates generally to a method of inhibiting corrosion in storage and transport vessels. More specifically, the invention pertains to a method of inhibiting corrosion on the inner surface of vessels that hold corrosive materials and preventing contamination of the material within the vessel.

### BACKGROUND

Storing and transporting corrosive materials, such as fertilizer solutions, nitrogen-based solutions, ammonia solutions, urea ammonium nitrate (“UAN”), and the like creates a variety of problems. The magnitude of these problems increases with the corrosiveness of the materials. Some substances produce a considerable amount of corrosion damage, requiring actual repair of the transport or storage container or vessel (hereinafter sometimes collectively referred to as “vessel”). Corrosion issues in vessels that hold UAN is of particular relevance due to its commercial popularity and economical use in agricultural applications. Similar corrosiveness issues are present for the storage and transport of a variety of materials. As an exemplary material, a description of UAN and related corrosion issues is provided below.

The production of UAN solutions includes blending urea solution, ammonium nitrate solution, and additional water in either a batch or continuous process. Ammonia is sometimes added to the UAN to act as a pH buffer. UAN is typically manufactured with about 20 percent by weight water and for field applications is generally diluted with water to about 28 percent by weight water. The former is generally referred to as UAN 32 (32 percent total nitrogen content), which typically has about 45 percent by weight ammonium nitrate, about 35 percent by weight urea, and about 20 percent by weight water. The latter is generally referred to as UAN 28 (28 percent total nitrogen content), which typically has about 39 percent by weight ammonium nitrate, about 31 percent by weight urea, and about 30 percent by weight water. Economically, such UAN solutions are desirable as compared to solids because herbicides can be blended with UAN allowing for one pass application of both fertilizer and herbicide.

A persistent problem in the production, storage, transportation, and application of UAN solutions is their corrosiveness towards steel. The solutions are quite corrosive towards mild steel (e.g., up to 500 mils per year (“MPY”) on C1010 steel) and are therefore usually treated by the producer with a bulk corrosion inhibitor to protect tanks, pipelines, nozzels, etc. In particular, rust and corrosion on the inner surface of storage and transport vessels, as well as piping systems used to fill or empty the vessels, is a major problem. Corrosion products, such as sludge, can also plug spray nozzles in fertilizer application equipment and irrigation booms. Without adequate corrosion inhibition, UAN solutions in storage and transport vessels can become discolored in a short period. For example, bloom rust formation in railcars leads to UAN solutions acquiring a red or orange hue. UAN is normally a clear liquid, so such discoloration is not desirable and in many cases leads to product waste.

Exacerbating the corrosive nature of UAN is that often a substantial volume of UAN is left in the vessel (sometimes referred to as a “heel”). This heel leads to direct corrosion on the surface of the vessel, especially on the bottom surface, and on the vessel drain fittings. After unloading the vessel, such as a railcar, thin films of corrosive material left on the walls and the heel in the bottom of the railcar can produce bloom rust that leads to sludge formation. UAN transport vessels and storage tanks normally undergo formal inspection every few years. The first step of this inspection is often sandblasting or pressure water washing the inner surface of the vessels and/or tanks, which usually removes all existing corrosion inhibitors and natural or chemical passivation surfaces.

After being cleaned or repaired, railcars are often stored in a humid ambient environment for extended periods before being returned to service. Considerable bloom rust forms on the inner surface of the railcar during such storage periods. Bulk corrosion inhibitors typically used in UAN solutions need several months to reestablish a protective film or passivate the inner surface of the vessel or railcar. Thus, newly inspected, cleaned, and/or repaired railcars often have UAN color quality concerns, caused by the heel or sludge mentioned above.

In addition, corrosion that results from the thin film left on the walls and the heel left on the bottom of storage or transport vessels creates a sludge that can also contribute to pitting and corrosion of such vessels and discoloration of the next UAN load. In particular, sludge collects in low spots on the vessel floor, such as the chine weld connecting the vessel walls to the floor or along the lower plate of a lap weld. Sludge formation may occur by bloom rust (i.e., corrosion product) dropping off or sliding down the vessel walls to the bottom of the vessel. It is therefore particularly useful for a corrosion inhibitor to reduce rust and corrosion, and in particular, bloom rust generation.

Corrosion in railcars also creates a wide variety of logistical problems. For example, before a railcar can be inspected or repaired, the entire inner surface of the car must be cleaned, typically by sandblasting, an expensive and time-consuming process. It is highly desirable to keep the inner surface of the railcar in clean, rust-free, and corrosion-free condition while the railcar awaits return to service. Further, if a fresh load of UAN is added to a railcar that has bloom rust on its inner surface or a rusty heel of old UAN pooled on the bottom of the railcar as sludge, the entire load could be discolored. Quite possibly, the discoloration causes point-of-delivery rejection, which in turn creates extra expenses for return and replacement and causes product waste. Such an occurrence could also damage the quality reputation of the UAN supplier.

General remedies used in the past to inhibit corrosion UAN-caused include high levels (usually hundreds or thousands of mg/kg) of phosphate or polyphosphate salts added directly to the UAN solution to serve as bulk corrosion inhibitors. These remedies fell into disfavor because the phosphates precipitated with other constituents, such as iron, calcium, magnesium, etc. Such precipitates led to unfavorable deposits on the bottom of vessels (as described above) as well as plugging of spray application devices.

Various types of organic film-forming corrosion inhibitors (“filmers”), such as phosphate esters and the like, have also been added to UAN solutions as bulk corrosion inhibitors, but these typically suffer from several problems. Due to filmers' surfactant nature, they may contribute to undesirable foaming during loading or unloading of the UAN. Some anti-foam additives can become less effective with time, so the foaming problem can be addressed initially but may often become problematic before or during application of the UAN solution. If the filmer is not well dispersed in the UAN solution, it becomes less effective.

The selection of corrosion inhibitors for liquid fertilizer solutions is made more difficult by the presence of environmental considerations. Since the fertilizer solutions are applied to crops, for example, they must be free of compounds which are toxic to the crops being fertilized, and must also facilitate compliance with industrial hygiene standards for the personnel applying the fertilizer. Thus, fluoride compounds, as one example, are undesirable in UAN solutions because they are generally agrotoxins.

Other corrosion inhibitors that are sometimes used in boilers and cooling towers, such as zinc, are incompatible with the relatively more severely corrosive UAN. Other well-known corrosion inhibitors, such as molybdate and tungstate (U.S. Pat. No. 5,376,159 incorporated by reference herein in its entirety) have also found application in UAN service. Even these additives, however, do not prevent bloom rust formation in storage and transport vessels. These “passivating” corrosion inhibitors function by forming insoluble complexes with Fe²⁺ ions as it is generated at the metal surface. These types of corrosion inhibitors are thus not effective at preventing rust/sludge build-up, particularly when large amounts of Fe²⁺ ions are present, such as when the vessel is off-specification. These insoluble iron ions can form complexes when brought into contact with acidic UAN solutions and contribute to voluminous sludge formation/deposition and under-deposit corrosion.

In addition to the above-described bulk corrosion inhibitors directly added to the UAN solution, vessel coatings have also been developed in an attempt to prevent and inhibit corrosion. Such coatings provide a layer on the inner surface of a vessel to prevent contact of the UAN with the inner surface of the vessel. For example, one such coating is mineral oil; however, addition of UAN leads to the rapid removal of the oil. Other types of coatings include cured-in-place rubber or epoxy liners placed on the inner surface of a storage or transport vessel to prevent contact of the UAN with the inner surface. Such liners can suffer from cracking or pinhole defects that lead to rapid pitting of any small exposed metal surface. Another example is U.S. Pat. No. 5,962,618 (incorporated by reference herein in its entirety), which describes a polyurea spray railcar lining system. Such liners very often prove to be cost prohibitive.

There thus exists a need to provide improved corrosion resistance for storage and transport vessels that carry corrosive substances. In particular, there exists a need to inhibit corrosion on the inner surface of stationary and mobile transport vessels that hold nitrogen-based solutions and other corrosive materials. Improved corrosion resistance and inhibition will lead to improved product quality (e.g., clarity due to the absence of rust which causes reddening of the material within the vessel) and a concomitant increase in profitability.

### SUMMARY

Accordingly, this invention addresses the problem of preventing rust and corrosion from forming on an inner surface of storage and transport vessels designed to carry loads including fertilizer solutions, nitrogen-based solutions, urea ammonium nitrate solutions (“UAN”), aqua ammonia solutions, urea liquor solutions, ammonium sulfate solutions, molasses, potassium sulfate, and other corrosive materials. It should be appreciated that the method of the invention may be used to prevent corrosion in any type of storage or transport vessel, such as railcars, barge compartments, storage tanks, and the like. Although these vessels are typically constructed of steel, as explained in the Examples below, it is contemplated that the vessels may also be constructed of other suitable materials.

The invention includes a method of inhibiting corrosion on a vessel in corrosive service. The method includes providing an empty vessel; applying an effective amount of a temporary water-based corrosion inhibitor or an effective amount of a temporary organic solvent-based corrosion inhibitor to an inner surface of the empty vessel; and drying the inner surface of the empty vessel.

The invention further includes a method of preventing contamination and maintaining quality of a corrosive material within a vessel. The method includes providing an empty vessel; applying an effective amount of a water-based corrosion inhibitor or an effective amount of an organic solvent-based corrosion inhibitor to an inner surface of the empty vessel; drying the inner surface of the empty vessel; and filling the vessel with the corrosive material.

An advantage of the invention is to provide a method of inhibiting corrosion on a vessel in corrosive service.

Another advantage of the invention is to provide a method of inhibiting corrosion in a vessel by applying a water-based corrosion inhibitor or an organic solvent-based corrosion inhibitor to the inner surface of the vessel.

A further advantage of the invention is to provide a method of preventing discoloration or contamination of a material or solution transported or stored in a vessel.

An additional advantage of the invention is to provide a method of maintaining quality of a material or solution transported or stored in a vessel.

Still another advantage of the invention is to provide a cost-effective and efficient method of inhibiting rust and corrosion in storage and transport vessels.

A further advantage of the invention is to provide a method of preventing bloom rust and sludge formation in storage and transport vessels to prevent discoloration of the material within the vessel and to prevent vessel-damaging corrosion.

Another advantage of the invention is to treat the inner surface of storage and transport vessels, such as railcars, barge compartments, and storage tanks to prevent bloom rust and sludge formation.

Yet another advantage of the invention is to provide a method of using water-based corrosion-inhibiting formulations to inhibit rust and corrosion on the inner surface of storage and transport vessels including formulations having from about 2 to about 16 percent by weight of one or more corrosion inhibitor formulations, from about 0.3 to about 1.2 percent by weight glycol ether, from about 7 to about 12 percent by weight naphthenic oil being from about 80 to about 120 cP, less than 1 percent by weight preservative, and the remainder water.

A further advantage of the invention is to provide a method of using organic solvent-based corrosion-inhibiting formulations to inhibit rust and corrosion on the inner surface of storage and transport vessels including formulations having from about 25 to about 50 percent by weight of one or more corrosion-inhibiting formulations, and from about 50 to about 75 percent of paraffinic solvent.

### DETAILED DESCRIPTION

“UAN” as used herein includes any grade of fertilizer solutions having a mixture of urea and ammonium nitrate in water (described in further detail above), including common grades of UAN 18, UAN 28, and UAN 32, where the numbers indicate total nitrogen content.

“Vessel” as used herein includes any container, cylinder, drum, barge compartment, storage tank, railcar, etc. which is capable of storing or transporting any corrosive substance regardless of degree of corrosiveness. Such vessels are typically constructed of steel.

“Corrosive substances or materials” as used herein include, but are not limited to fertilizer solutions, nitrogen-based solutions, urea ammonium nitrate solutions, aqua ammonia solutions, urea liquor solutions, ammonium sulfate solutions, molasses, potassium sulfate solutions, molasses, and other similar materials.

The method of the invention includes providing a new or cleaned storage or transport vessel. In one embodiment, the method includes cleaning the inner surface of the vessel. Such cleaning may be accomplished using a variety of techniques including, but not limited to sandblasting, high-pressure water washing (where the water may optionally include additional solvents, cleaners, detergents, or the like), chemical rust removal, and other suitable cleaning means. It is contemplated that any appropriate or suitable method or substance of cleaning the vessel surface or removing rust from the vessel surface may be employed.

In one embodiment, the method includes cleaning the inner surface of the vessel with a cleaning composition including from about 20 to about 40 percent by weight of a chelating or sequestering agent, from about 20 to about 40 percent by weight base, and the remainder water. In a preferred embodiment, the composition includes from about 28 to about 32 percent by weight of an organic chelating agent, from about 25 to about 30 percent by weight of base, and the remainder water. In a more preferred embodiment, the composition includes from about 29 to about 30 percent by weight chelating agent, from about 27 to about 28 weight percent base, and the remainder water. Preferably, the water is deionized water.

In alternative embodiments, the organic chelating or sequestering agent may include organic chelating compounds, such as ethylenediaminetetracetic acid; ethylenediamine; nitrilo-2,2′,2″-triacetic acid; diethylenetriaminepentaacetic acid; 1-(2-pyridylazo)-2-naphthol; 1-(3-hydroxy-6-(hydroxymethyl)-4-oxopyridyl)-2-ethanesulfonic acid; 1,10-phenanthroline; 1,10-phenanthroline-2-carboxylic acid; 1,2-bis(2-aminophenoxy)ethane N,N,N′,N′-tetraacetic acid; 1-hydroxyethylidene-1,1-diphosphonic acid; 1,14-bis(2,3-dihydroxybenzoyl)-5,10-bis(1-hydroxy-2-pyridon-6-oyl)-1,5,10,14-tetraazatetradecane; 2,6-pyridinedicarbohydroxamic acid; 1,2-diethyl-3-hydroxypyridin-4-one; 1,4,7,10-tetraazacyclododecane-1,4,7,10-tetraacetic acid; 1-hydroxy-5-methoxy-6-methyl-2(1H)-pyridinone; 1-methyl-3-hydroxypyridine-2-one; 2′-(2-hydroxyphenyl)-2′-thiazoline-4′-carboxylic acid; 2,2′-(ethylenediimino)dibutyric acid; 2,3-dimercaptopropionic acid; 1,2-bis(3,5-dioxopiperazin-1-yl)ethane; or 3-hydroxy-4-pyridone.

In one embodiment, the basic solution of the cleaning composition includes a monovalent base, such as NaOH, KOH, or the like. In alternative embodiments, the basic solution includes a calcium hydroxide, ammonium hydroxide, magnesium hydroxide, or the like. It is contemplated that any suitable base, such as monovalent base, divalent base, amines, tertiary amines, quaternary amines, quaternary compounds, or combinations thereof may be used.

In one embodiment, the method of the invention includes sandblasting or high-pressure water washing the vessel to provide a fresh, clean surface prior to applying the water-based corrosion inhibitor or the organic solvent-based corrosion inhibitor (described in more detail below). In another embodiment, the vessel is new and thus may not need to be cleaned. Such a cleaner may be applied and used in any suitable fashion, such as spraying, immersion, brushing, rolling, mopping, etc.

It should be appreciated that any appropriate cleaner or cleaning method may be used to remove oxide or rust buildup from the vessel surface. This aspect of the invention includes a new or freshly cleaned surface and a person of ordinary skill in the art may use the methods described herein or any other appropriate or suitable method to attain the clean surface.

In one embodiment, the invention includes applying an effective amount of a corrosion-inhibiting composition to an inner surface of a vessel. The corrosion inhibitor is typically applied to the vessel while the vessel is empty. It should be appreciated that the corrosion inhibitor may be any suitable corrosion inhibitor including water-based and organic solvent-based compositions.

In one embodiment, the corrosion-inhibiting composition is a water-based composition and includes from about 2 to about 16 percent by weight of one or more corrosion inhibitor formulations, from about 0.3 to about 1.2 percent by weight glycol ether, from about 7 to about 12 percent by weight naphthenic oil (from about 80 to about 120 cP), and the remainder water. In a preferred embodiment, the corrosion-inhibiting composition includes from about 2 to about 6 percent by weight of a first corrosion inhibitor formulation, from about 2 to about 6 percent of a second corrosion inhibitor formulation, from about 0.5 to about 0.9 percent by weight glycol ether, from about 7.5 to about 10.5 percent by weight naphthenic oil (from about 90 to about 110 cP), less than 1 percent by weight preservative, and the remainder water. In another preferred embodiment, the corrosion-inhibiting composition includes from about 3.8 to about 4.1 percent by weight of a first corrosion inhibitor formulation, from about 3.7 to about 4.2 percent of a second corrosion inhibitor formulation, from about 0.6 to about 0.8 percent by weight glycol ether, from about 8.8 to about 9.6 percent by weight naphthenic oil (from about 99 to about 105 cP), less than 1 percent by weight preservative, and the remainder water.

In alternative embodiments, the corrosion inhibitor formulations may include Alox 165, 165L, 318FS, 319FS, 606, 606-55, 606-55HF, 606-70, 940AS, 1727DS, 2211Y, 2213CS, 2213D, 2278S, 2280S, 2289S, 2290AS, 2290S, 2296; Aqualox 2268S, 2320S, 2328S; Addco CP-OB-2; or combinations thereof, and the like (each listed formulation available from Lubrizol Corporation, Wickliffe, Ohio).

It is contemplated that the glycol ether may include 2-methoxyethanol; 2-ethoxyethanol; 2-butoxyethanol; 2-propoxyethanol; 2-phenoxyethanol; 2-(2-methoxyethoxy)ethanol; 2-(2-ethoxyethoxy)ethanol; 2-(2-butoxyethoxy)ethanol; 2-(2-propoxyethoxy)ethanol; 2-(2-hexyloxyethoxy)ethanol; 2-[2-(2-methoxyethoxy)ethoxy]ethanol; 2-[2-(2-ethoxyethoxy)ethoxy]ethanol; 2-[2-(2-butoxyethoxy)ethoxy]ethanol; 2-[2-(2-propoxyethoxy)ethoxy]ethanol; combinations thereof, and the like.

Representative preservatives include 1,3-dimethylol-5,5-dimethyl hydantoin, iodopropynyl butylcarbamate; 1,3-Bis(hydroxymethyl)-5,5-dimethylimidazolidin-2,4-dione (32 solution in water); 1,3-dimethylol-5,5-dimethyl hydantoin; 1-bromo-3-chloro-5,5-dimethyl hydantoin; combinations thereof, and the like.

In another embodiment, the corrosion-inhibiting composition is an organic solvent-based composition and includes from about 25 to about 50 percent by weight of one or more corrosion-inhibiting formulations (as described above for the water-based composition), and from about 50 to about 75 percent of paraffinic solvent. In a preferred embodiment, the composition includes from about 35 to about 45 percent by weight of the corrosion-inhibiting formulation, and from about 55 to about 65 percent by weight of the paraffinic solvent. In another preferred embodiment, the composition includes from about 50.9 to about 60.5 percent by weight of the paraffinic solvent.

In alternative embodiments, the paraffinic solvent may include any suitable hydrocarbon fluid. For example, in one embodiment, the solvent has an aniline point from about 67° C. to about 77° C., aromatics content from about 0.08 to about 0.22 percent by weight, initial boiling point from about 159° C. to about 210° C., flash point from about 40° C. to about 85° C., and specific gravity from about 0.77 to about 0.82 (at 15.6° C.). In a preferred embodiment, the paraffinic solvent has an aniline point from about 68° C. to about 74° C., aromatics content from abut 0.09 to about 0.16 percent by weight, initial boiling point from about 188° C. to about 194° C., flash point from about 62° C. to about 65° C., and specific gravity from about 0.78 to about 0.80 (at 15.6° C.). In another preferred embodiment, the paraffinic solvent has an aniline point from about 71° C. to about 73° C., aromatics content from abut 0.095 to about 0.11 percent by weight, initial boiling point from about 189° C. to about 192° C., flash point from about 63° C. to about 64° C., and specific gravity from about 0.785 to about 0.796 (at 15.6° C.).

Though not required in accordance with the invention, it should be appreciated that the above-described corrosion inhibitors may include adjuncts, such as preservatives, other solvents, other corrosion inhibitors, and bulk corrosion inhibitors. Furthermore, it is contemplated that these corrosion inhibitors may be applied using any number of techniques, as determined by the user of ordinary skill in the art. For example, these techniques may include spraying with any appropriate spray apparatus, rolling using a paint roller or the like, brushing using a paintbrush or the like, swabbing using a mop or the like, or by using any other suitable method or technique.

In one aspect, the method may be combined with bulk inhibitors, such as Corrogard™ IWC-36, IWC-235, or IWC-278; NITROSolve™ 110, 200, 300, or 330 (available from Nalco Company® in Naperville, Ill.); or the like. In alternative embodiments, the bulk corrosion inhibitors may include silicates, borates, molybdates, tungstates, combinations thereof, or any other suitable bulk corrosion inhibitor(s). Under certain conditions, a synergistic effect is observed when the method of the invention is combined with a bulk inhibitor, as described in the Examples below.

In another embodiment, the method of the invention includes a drying step. This step includes exposing the treated surface to flowing air and appropriate temperature conditions for a sufficient period to allow evaporation of the water or organic-solvent of the corrosion inhibitor. Such drying may include several alternative methods, including letting the surface naturally air-dry, exposing the surface to an appropriate temperature with an adequate volume of circulating air for a sufficient amount of time, or combinations thereof. Factors affecting appropriate drying conditions include the particular type of solvent used, especially whether the solvent is aqueous or organic, the ambient temperature, and the ambient humidity. Of particular importance is the type of solvent used for the corrosion inhibitor. For example, an organic solvent-based corrosion inhibitor (high volatile organic chemical (“VOC”) content) would require different drying conditions than a water-based corrosion inhibitor (low VOC content). The conditions employed should be sufficient to evaporate the solvent, thus leaving the corrosion inhibitor adsorbed to the inner surface of the vessel.

It is contemplated that conditions such as drying temperatures, airflow, and time of exposure to heat and airflow will need to be adjusted to accommodate ambient conditions and the VOC content of the solvent. A person of ordinary skill in the art should easily be able to understand and make these adjustments. For example, if the corrosion inhibitor includes a water-based solvent, longer drying times and possibly increased temperatures will generally be required because water is a low VOC solvent. Further examples are provided below.

It should be appreciated that the drying step may, in some embodiments, require airflow. The user may dry the treated surface using techniques such as exposing to a blast of warm air for a sufficient period, naturally air-drying, or exposing to ambient heat if the temperature is sufficiently warm. It is contemplated that any method or technique of introducing airflow into the vessel may be used, including an exhaust fan, duct fan, or any other suitable air-circulating device. In some of the embodiments described, an external or internal heat source may be required to facilitate evaporation of the water or organic solvent from the treated surface. The heat may be applied either directly or indirectly to the treated surface. Alternative heat sources may include heat generated via: electricity; petroleum-based or other fuel sources; steam or boiler system; kinetic means; or heat generated using any suitable energy source using any suitable heat-generating device.

### EXAMPLES

The following examples illustrate experiments used in testing the effectiveness of the invention (Examples 1 to 3) and methods for carrying out the invention (Examples 4 and 5) and should be understood to be illustrative of, but not limiting upon, the scope of the invention defined in the appended claims.

### Example 1

To illustrate the effectiveness of an exemplary corrosion-inhibiting composition (RustpHree™ 4746A available from Nalco Company® in Naperville, Ill.) in the presence of bulk corrosion inhibitors, mild steel test coupons as above were separated into three experimental groups and a fourth control group, as shown in Table 1. The three experimental group test coupons were pre-treated (i.e., coated) with RustpHree 4746A and air-dried. The control test coupon was not pre-treated (i.e., no coating and no bulk inhibitor). Each test coupon was submerged in a constantly stirred (about 400 rpm stir speed) volume of test solution for a 45-day period. Stirring at this rpm simulated high shear to demonstrate persistence of the RustpHree 4746A coating. The base test solution in each sample was ammonia-stripped UAN 32 (having a starting pH of about 5.9). As shown in Table 1, amounts of the bulk corrosion inhibitors NITROSolve 110 or NITROSolve 200 were added to certain samples.

A corrosion rate for the untreated control and the RustpHree 4746A only test coupon was measured in mils per year (“MPY”), determined by direct coupon weight. Because the corrosion rates for the test coupons having RustpHree 4746A in combination with a bulk corrosion inhibitor were too small to determine by direct coupon weight (thus demonstrating the synergistic effect of the combination), total solution iron levels were measured to determine MPY corrosion of those test coupons. The test method for calculating total iron levels was the Ferrozine calorimetric analysis method (available from Hach, Inc., Loveland, Colo.). Using the untreated control test coupon as a baseline, the results indicate a substantial reduction in test coupon corrosion rate in the presence of RustpHree 4746A, with a greater reduction observed in the presence of bulk corrosion inhibitors.

TABLE 1

| SAMPLE TREATMENT | MPY | BASIS |
|---|---|---|
| Untreated control | 11 | Weight |
| RustpHree 4746A only | 3.6 | Weight |
| RustpHree 4746A | 0.075 | Total solution iron |
| 160 ppm NITROSolve 110 | | |
| RustpHree 4746A | 0.061 | Total solution iron |
| 160 ppm NITROSolve 110 | | |
| RustpHree 4746A | 0.031 | Total solution iron |
| 110 ppm NITROSolve 200 | | |
| RustpHree 4746A | 0.022 | Total solution iron |
| 110 ppm NITROSolve 200 | | |

### Example 2

This example illustrates and compares the effectiveness of RustpHree 4746A and PROTEXO™ 1125 (available from Nalco Company® in Naperville, Ill.) as corrosion inhibitors in both the absence and presence of bulk corrosion inhibitors. Mild steel test coupons as above were separated into five experimental groups and a sixth control group, as shown in Table 2. The experimental group test coupons were either pre-treated with RustpHree 4746A and air-dried or pre-treated with PROTEXO 1125 and air-dried. The control test coupon was not pre-treated (i.e., no coating and no bulk inhibitor). Each coupon was submerged in a constantly stirred (about 400 rpm stir speed) volume of test solution for a 17-day period. Stirring at this rpm simulated high shear to demonstrate persistence of the coatings. The base test solution in each sample was ammonia-stripped UAN 32 (having a starting pH of about 5.7). As shown in Table 2, 110 ppm of the bulk corrosion inhibitor NITROSolve 220 was added to certain samples.

A corrosion rate for each coupon was measured in MPY, determined by direct coupon weight. As seen in Table 2, using the untreated control test coupon as a baseline, the results indicate a substantial reduction in test coupon corrosion rate in the presence of both RustpHree 4746A and PROTEXO 1125.

TABLE 2

| TREATMENT GROUPS | MPY |
|---|---|
| Untreated control | 62.0 |
| RustpHree 4746A only | 0.3 |
| PROTEXO 1125 only | 0.3 |
| 110 ppm NITROSolve 220 only | 0.1 |
| RustpHree 4746A | 0.3 |
| 110 ppm NITROSolve 220 | |
| PROTEXO 1125 | 0.2 |
| 110 ppm NITROSolve 220 | |

### Example 3

Donut-shaped mild steel (i.e., non-galvanized) test coupons of about 1.4 inch outer diameter, 0.5 inch inner diameter, and 0.1 inch thickness were cleaned with a solvent and visually examined for any metallurgical flaws. Any coupon suspected of having flaws was rejected and not used in the study. Test coupons were either pre-treated with RustpHree 4746A or were not pre-treated, as above. The coupons were dipped one time each day for 15 minutes into UAN 28 and were then held in the vapor space above the UAN solution in semi-sealed containers at room temperature for 45 minutes thereafter. This test was repeated each day over the course of 13 days.

Table 3 shows the results of the 13-day test cycle, which indicate a substantial reduction in relative corrosion rate for pre-treated versus untreated test coupons. Column 1 describes the test coupon sample. Column 2 indicates the calculated relative corrosion rate (based upon coupon weight) in MPY. Column 3 indicates the relative percent corrosion in comparison to untreated test coupons.

TABLE 3

| | | PERCENT |
|---|---|---|
| SAMPLE TYPE | MPY | CORROSION |
| Untreated #1 | 1.43 | 100% |
| Untreated #2 | 1.26 | 100% |
| RustpHree 4746A #1 | 0.21 | 15.54% |
| RustpHree 4746A #2 | 0.14 | 10.67% |

### Example 4

An effective amount of RustpHree 4746A was applied to the inner surface of a 100-ton railcar (i.e., about 20,000 gallon capacity) being about 46-feet long and having about a 9-foot diameter. The railcar was constructed of A-516 grade 70 steel that was about 7/16 inch thick. The railcar's welds met DOT 111A199W1 specifications.

In this example, about 4 gallons of the relatively high VOC content (about 5.8 pounds per gallon of mineral spirits or other paraffinic or organic solvent) corrosion inhibitor was sprayed. The ambient air temperature was approximately 85° F. and the relative humidity was about 50 to 60 percent. Exposing the railcar to sunlight for 24 to 48 hours was sufficient for complete solvent evaporation (the internal temperature of the railcar is estimated to reach about 150 to 160° F. due to sun exposure). In this embodiment, less stringent drying conditions are required because of the high VOC content.

### Example 5

An effective amount of PROTEXO 1125 was applied to the inner surface of a 100-ton (i.e., about 20,000 gallon capacity) railcar. In this example, about 4 gallons of the relatively low VOC content (about 0.06 pounds per gallon) was sprayed. To effectively dry the applied PROTEXO 1125, an air nozzle was inserted into the railcar's man-way dome and air heated to about 200° F. air was introduced at a flow rate of about 1,700 cubic feet per minute for about 3 hours. The heat was subsequently turned off and the same flow rate of cool (about 70° F.) ambient air continued for an additional 12 hours to sufficiently dry the inner surface.

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

The invention is claimed as follows:

1. A method of inhibiting corrosion on a vessel in corrosive service, said method comprising:
a) providing an empty vessel;
b) applying an effective amount of a corrosion-inhibiting composition to an inner surface of the empty vessel, said composition including:
i) from about 2 to about 16 percent by weight of one or more corrosion inhibitor formulations, from about 0.3 to about 1.2 percent by weight glycol ether, from about 7 to about 12 percent by weight naphthenic oil being from about 80 to about 120 cP, less than 1 percent by weight preservative, and the remainder water; or
ii) from about 25 to about 50 percent by weight of one or more corrosion-inhibiting formulations, and from about 50 to about 75 percent of paraffinic solvent; and
c) drying the inner surface of the empty vessel.

2. The method of claim 1, wherein the vessel is selected from the group consisting of: a railcar, a barge compartment, and a storage tank.

3. The method of claim 1, wherein the vessel is selected from the group consisting of: a railcar having about up to a 100-ton capacity, a barge compartment having up to about a 50,000-ton capacity, and a storage tank having up to about a 40,000-ton capacity.

4. The method of claim 1, including cleaning the inner surface of the empty vessel

5. The method of claim 1, including sandblasting the inner surface of the empty vessel.

6. The method of claim 1, including high-pressure water washing the inner surface of the empty vessel.

7. The method of claim 1, including cleaning the inner surface of the empty vessel with a cleaning composition having from 20 to about 40 percent by weight of a chelating or sequestering agent, from about 20 to about 40 percent by weight base, and the remainder water.

8. The method of claim 1, including brushing, spraying, rolling, or swabbing an effective amount of the corrosion-inhibiting composition to the inner surface of the empty vessel.

9. The method of claim 1, wherein drying the inner surface of the empty vessel includes applying either ambient temperature airflow or heated airflow to said inner surface.

10. The method of claim 1, including drying the inner surface of the empty vessel by applying heat either directly or indirectly to said inner surface.

11. The method of claim 1, including drying the inner surface of the empty vessel and thereafter filling the empty vessel with a corrosive material.

12. The method of claim 1, including drying the inner surface of the empty vessel and thereafter filling the empty vessel with one or more materials selected from the group consisting of: fertilizer solutions, nitrogen-based solutions, urea ammonium nitrate solutions, aqua ammonia solutions, urea liquor solutions, ammonium sulfate solutions, molasses, potassium sulfate solutions, and molasses.

13. The method of claim 1, including filling the empty vessel with a material having an effective amount of one or more bulk corrosion inhibitors.

14. A method of preventing contamination and maintaining quality of a corrosive material within a vessel, said method comprising:
a) providing an empty vessel;
b) applying an effective amount of a corrosion-inhibiting composition to an inner surface of the empty vessel, said composition including:
i) from about 2 to about 16 percent by weight of one or more corrosion inhibitor formulations, from about 0.3 to about 1.2 percent by weight glycol ether, from about 7 to about 12 percent by weight naphthenic oil being from about 80 to about 120 cP, less than 1 percent by weight preservative, and the remainder water; or
ii) from about 25 to about 50 percent by weight of one or more corrosion-inhibiting formulations, and from about 50 to about 75 percent of paraffinic solvent; and
c) drying the inner surface of the empty vessel; and
d) filling the vessel with the corrosive material.

15. The method of claim 14, wherein the corrosive material is selected from the group consisting of: fertilizer solutions, nitrogen-based solutions, urea ammonium nitrate solutions, aqua ammonia solutions, urea liquor solutions, ammonium sulfate solutions, molasses, potassium sulfate solutions, and molasses.

16. The method of claim 14, wherein the vessel is selected from the group consisting of: a railcar, a barge compartment, and a storage tank.

17. The method of claim 14, wherein the vessel is selected from the group consisting of: a railcar having up to about a 100-ton capacity, a barge compartment having up to about a 50,000-ton capacity, and a storage tank having up to about a 40,000-ton capacity.

18. The method of claim 14, including cleaning the inner surface of the empty vessel using one or more techniques selected from the group consisting of: sandblasting; high-pressure water washing; and applying a cleaning composition having from 20 to about 40 percent by weight of a chelating or sequestering agent, from about 20 to about 40 percent by weight base, and the remainder deionized water.

19. The method of claim 14, wherein the material includes an effective amount of one or more bulk corrosion inhibitors.

20. The method of claim 14, including brushing, spraying, rolling, or swabbing an effective amount of the corrosion-inhibiting composition to the inner surface of the empty vessel.
